(19) United States
(12) Patent Application Publication
(10) Pub. No.: US 2024/0234712 A9
(43) Pub. Date: Jul. 11, 2024

(54) NON-AQUEOUS ELECTROLYTE SECONDARY BATTERY

(71) Applicant: Panasonic Energy Co., Ltd., Moriguchi-shi, Osaka (JP)

(72) Inventors: Takayuki Ishikawa, Osaka (JP); Kaoru Nagata, Osaka (JP); Masanori Maekawa, Osaka (JP)

(73) Assignee: Panasonic Energy Co., Ltd., Moriguchi-shi, Osaka (JP)

(21) Appl. No.: 18/278,277

(22) PCT Filed: Feb. 22, 2022
(86) PCT No.: PCT/JP2022/007153

§ 371 Date: Aug. 22, 2023

(30) Foreign Application Priority Data
Mar. 8, 2021 (JP) 2021-036442

(51) Int. Cl. H01M 4/525; H01M 4/505; H01M 10/05

(52) U.S. Cl. CPC H01M 4/525; H01M 4/505; H01M 10/05; H01M 2004/028

(57) ABSTRACT

A non-aqueous electrolyte secondary battery that is one aspect of the present disclosure is provided with a positive electrode, a negative electrode, and a non-aqueous electrolyte, the positive electrode having a positive electrode current collector and a positive electrode mixture layer that contains a positive electrode active material and that is formed on the surface of the positive electrode current collector, the positive electrode active material including a lithium-containing composite oxide represented by a prescribed general formula, the lithium-containing composite oxide having secondary particles formed by aggregation of primary particles, Ca being present on the surfaces and in the interiors of the secondary particles, and the proportion of Ca present on the surfaces of the secondary particles being 12-58% relative to the total amount of Ca present on the surfaces and in the interiors of the secondary particles.

### TECHNICAL FIELD

The present disclosure relates to a non-aqueous electrolyte secondary battery.

### BACKGROUND

In recent years, from the perspective of achieving higher capacity, there are cases where a lithium-containing composite oxide such as lithium nickel cobalt oxide is used as a positive electrode active material. However, when the Ni content in the lithium-containing composite oxide is increased in order to further increase capacity, reaction activity at the surface of the lithium-containing composite oxide becomes higher so that reactivity with the electrolyte solution becomes increased, and this may result in a higher rate at which the battery capacity decreases due to repeated charging and discharging. Patent Literature 1 discloses a technique of suppressing deterioration of the charge-discharge cycle characteristic by attaching a compound such as CaO to the surface of the lithium-containing composite oxide.

### CITATION LIST

### Patent Literature

PATENT LITERATURE 1: Japanese Unexamined Patent Application Publication No.

### SUMMARY

### Technical Problem

As a result of intensive studies by the present inventors, it has been found that by causing Ca to be present only at the surface of the lithium-containing composite oxide, reaction between the lithium-containing composite oxide and the electrolyte solution cannot be sufficiently reduced, and there are cases where battery safety becomes degraded. In Patent Literature 1, battery safety is not considered, and there is still room for improvement therein.

Accordingly, an object of the present disclosure is to provide a non-aqueous electrolyte secondary battery which simultaneously achieves sufficient charge-discharge cycle characteristic and safety.

### Solution to Problem

A non-aqueous electrolyte secondary battery according to one aspect of the present disclosure includes a positive electrode, a negative electrode, and a non-aqueous electrolyte. The positive electrode includes a positive electrode current collector, and a positive electrode mixture layer formed on a surface of the positive electrode current collector and containing a positive electrode active material. The positive electrode active material contains a lithium-containing composite oxide represented by general formula LiₐNi_{b}Co_{c}Al_{d}MₑCa_{f}O_{g} (where 0.9≤a≤1.2, 0.85≤b≤0.95, 0<c≤0.1, 0<d≤0.1, 0≤e≤0.1, b+c+d+e=1, 0.0005≤f(b+c+d+e+f)≤0.01, 1.9≤g≤2.1, and M is at least one element selected from Mn, Fe, Ti, Si, Nb, Zr, Mo, and Zn). The lithium-containing composite oxide includes secondary particles formed by agglomeration of primary particles. Ca is present at the surface and in the interior of the secondary particles, and the ratio of Ca present at the surface of the secondary particles relative to the total amount of Ca present at the surface and in the interior of the secondary particles is 12% to 58%.

### Advantageous Effects of Invention

According to one aspect of the present disclosure, it is possible to simultaneously achieve sufficient charge-discharge cycle characteristic and safety in a non-aqueous electrolyte secondary battery.

### BRIEF DESCRIPTION OF DRAWINGS

FIG. 1 is an axial cross-sectional view of a cylindrical secondary battery according to an example embodiment.

### DESCRIPTION OF EMBODIMENTS

An example embodiment of a non-aqueous electrolyte secondary battery according to the present disclosure will now be described below in detail. Although a cylindrical battery in which a spiral-type electrode assembly is housed in a cylindrical battery housing is described below as an example, the electrode assembly is not limited to being of a spiral type, and may be of a laminated type formed by alternately laminating a plurality of positive electrodes and a plurality of negative electrodes one by one via separators. Further, the battery housing is not limited to being cylindrical, and may be, for example, rectangular, coin-shaped, or the like, or may be a pouch-shaped housing composed of a laminate sheet including a metal layer and a resin layer.

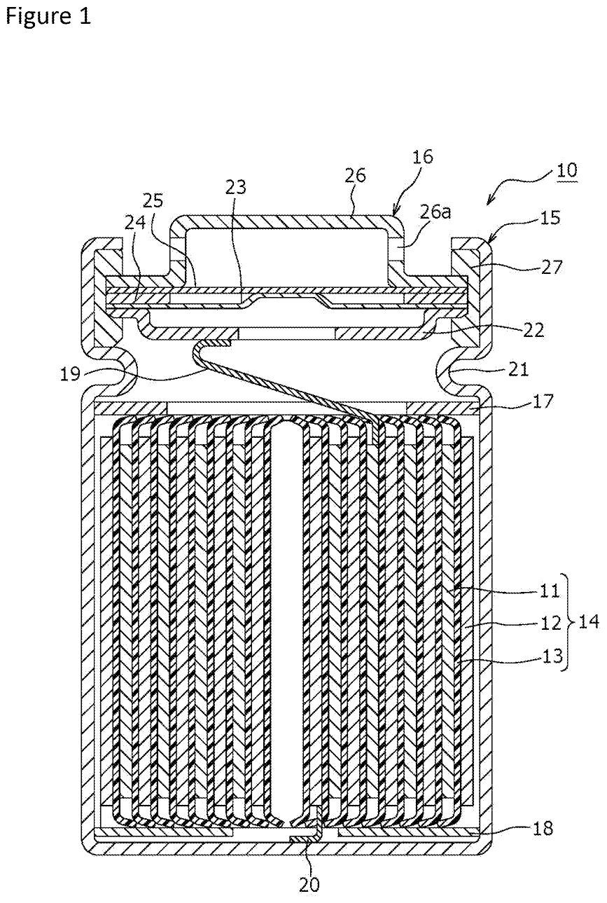

FIG. 1 is an axial cross-sectional view of a cylindrical secondary battery 10 according to an example embodiment. In the secondary battery 10 shown in FIG. 1, an electrode assembly 14 and a non-aqueous electrolyte (not shown in drawing) are housed in an outer casing 15. The electrode assembly 14 has a spiral structure formed by winding a positive electrode 11 and a negative electrode 12 with a separator 13 disposed between those electrodes. In the following, for convenience of explanation, a side toward a sealing assembly 16 will be described as “upper”, and a side toward the bottom portion of the outer casing 15 will be described as “lower”.

By having an opening end portion of the outer casing 15 being closed with the sealing assembly 16, the interior of the secondary battery 10 is hermetically sealed. Insulation plates 17 and 18 are provided above and below the electrode assembly 14, respectively. A positive electrode lead 19 extends upward through a through hole in the insulation plate 17, and is welded to a lower surface of a filter 22, which is the bottom plate of the sealing assembly 16. In the secondary battery 10, a cap 26, which is the top plate of the sealing assembly 16 electrically connected to the filter 22, serves as the positive electrode terminal. Further, a negative electrode lead 20 passes through a through hole in the insulation plate 18, extends toward the bottom portion of the outer casing 15, and is welded to the inner surface of the bottom portion of the outer casing 15. In the secondary battery 10, the outer casing 15 serves as the negative electrode terminal. In cases where the negative electrode lead 20 is provided at an end edge portion, the negative electrode lead 20 passes through the through hole in the insulation plate 18, extends toward the bottom portion of the outer casing 15, and is welded to the inner surface of the bottom portion of the outer casing 15.

The outer casing 15 is, for example, a bottomed cylindrical metal outer can. A gasket 27 is provided between the outer casing 15 and the sealing assembly 16, and hermetic sealing of the interior of the secondary battery 10 is thereby ensured. The outer casing 15 has a grooved portion 21, which is formed, for example, by pressing a side surface portion from outside, and which supports the sealing assembly 16. The grooved portion 21 is preferably formed in an annular shape along the circumferential direction of the outer casing 15, and supports the sealing assembly 16 on its upper surface via the gasket 27.

The sealing assembly 16 comprises a filter 22, a lower valve member 23, an insulation member 24, an upper valve member 25, and a cap 26, which are stacked in this order from the electrode assembly 14 side. Each of the members constituting the sealing assembly 16 has, for example, a disk shape or a ring shape, and the respective members other than the insulation member 24 are electrically connected to each other. The lower valve member 23 and the upper valve member 25 are connected to each other at their central portions, and the insulation member 24 is interposed between peripheral edge portions of these valve members. When the internal pressure of the battery increases due to abnormal heat generation, for example, the lower valve member 23 ruptures, and the upper valve member 25 is thereby caused to swell toward the cap 26 side and separate from the lower valve member 23, so that electrical connection between the two valve members is cut off. When the internal pressure increases further, the upper valve member ruptures, and gas is discharged from an opening 26a in the cap 26.

A detailed description will now be given below regarding the positive electrode 11, the negative electrode 12, the separators 13, and the non-aqueous electrolyte, which constitute the secondary battery 10, and in particular regarding a positive electrode active material contained in a positive electrode mixture layer constituting the positive electrode 11.

[Positive Electrode]

The positive electrode comprises a positive electrode current collector and a positive electrode mixture layer formed on a surface of the positive electrode current collector. The positive electrode mixture layer is preferably formed on both sides of the positive electrode current collector. As the positive electrode current collector, it is possible to use: a foil of a metal, such as aluminum, that is stable in the potential range of the positive electrode; a film having such a metal disposed on its surface layer; and the like. The positive electrode mixture layer contains, for example, a positive electrode active material, a binder, a conductive agent, and the like. The positive electrode can be produced by, for example, applying a positive electrode mixture slurry containing the positive electrode active material, the binder, the conductive agent, and the like onto the positive electrode current collector, drying the applied slurry to form a positive electrode mixture layer, and then rolling this positive electrode mixture layer.

Examples of the conductive agent contained in the positive electrode mixture layer include carbon-based particles such as carbon black (CB), acetylene black (AB), Ketjen black, and graphite. These may be used alone or by combining two or more thereof.

Examples of the binder contained in the positive electrode mixture layer include fluororesins such as polytetrafluoroethylene (PTFE) and polyvinylidene fluoride (PVdF), polyacrylonitrile (PAN), polyimide resins, acrylic resins, and polyolefin resins. These may be used alone or by combining two or more thereof.

The positive electrode active material contained in the positive electrode mixture layer includes a lithium-containing composite oxide represented by general formula LiₐNi_{b}Co_{c}Al_{d}MₑCa_{f}O_{g} (where 0.9≤a≤1.2, 0.8≤b≤0.95, 0<c≤0.1, 0<d≤0.1, 0≤e≤0.1, b+c+d+e=1, 0.0005≤f/(b+c+d+e+f)≤0.01, 1.9≤g≤2.1, and M is at least one element selected from Mn. Fe, Ti. Si, Nb, Zr, Mo, and Zn). By using the Ni—Co—Al-based lithium-containing composite oxide, it is possible to increase the capacity of the battery and at the same time suppress cation mixing, which involves Ni moving into Li sites. It is noted that the positive electrode active material may contain lithium-containing composite oxides other than those represented by the above general formula or other compounds within a range that does not impair the object of the present disclosure. Mole fractions of metal elements contained in the lithium-containing composite oxide are measured by inductively coupled plasma atomic emission spectrometry (ICP-AES).

The variable “a”, which represents the ratio of Li in the lithium-containing composite oxide, preferably satisfies 0.9≤a≤1.2, and more preferably satisfies 0.95≤a≤1.05. When “a” is less than 0.9, the battery capacity may become decreased as compared to when “a” satisfies the above range. When “a” exceeds 1.2, this may lead to deterioration of the charge-discharge cycle characteristic as compared to when “a” satisfies the above range.

The variable b, which represents the ratio of Ni to the total number of moles of metal elements excluding Li and Ca in the lithium-containing composite oxide, preferably satisfies 0.8≤b≤0.96, and more preferably satisfies 0.88≤b≤0.92. By setting b to 0.8 or greater, a high-capacity battery can be obtained. Further, by setting b to 0.96 or less, other elements such as Co and Al can be included, so that cation mixing can be suppressed.

The variable c, which represents the ratio of Co to the total number of moles of metal elements excluding Li and Ca in the lithium-containing composite oxide, preferably satisfies 0≤c≤0.10, and more preferably satisfies 0.04≤c≤0.06.

The variable d, which represents the ratio of Al to the total number of moles of metal elements excluding Li and Ca in the lithium-containing composite oxide, preferably satisfies 0≤d≤0.10, and more preferably satisfies 0.04≤d≤0.06. Since Al does not undergo a change in oxidation number during charging and discharging, inclusion of Al in transition metal layers is considered to stabilize the structure of the transition metal layers. When d exceeds 0.10, Al impurities may be generated and the battery capacity may become decreased.

M (M is at least one element selected from Mn, Fe, Ti, Si, Nb, Zr, Mo, and Zn) is an optional component. The variable e, which represents the ratio of M to the total muber of moles of metal elements excluding Li and Ca in the lithium-containing composite oxide, preferably satisfies 0≤e≤0.1.

The expression f(b+c+d+e+f), which represents the ratio of Ca to the total number of moles of metal elements excluding Li in the lithium-containing composite oxide, preferably satisfies 0.0005≤f(b+c+d+e+f)≤0.01, more preferably satisfies 0.001≤f/(b+c+d+e+f)≤0.005, and particularly preferably satisfies 0.0015=f/(b+c+d+e+f)≤0.0045.

The lithium-containing composite oxide includes secondary particles formed by agglomeration of primary particles, and Ca is present at the surface and in the interior of the secondary particles. Here, the statement “Ca is present in the interior of the secondary particles” means that Ca is present between the primary particles that constitute a secondary particle.

The secondary particles of the lithium-containing composite oxide are particles in which the volume-based median diameter (D50) is preferably 3 μm to 30 μm, more preferably 5 μm to 25 μm, and particularly preferably 7 μm to 15 μm. D50 means a particle size at which, in a volume-based particle size distribution, the cumulative frequency from the smaller particle size side reaches 50%, and is also called a mid-level diameter. The particle size distribution of the secondary particles of the lithium-containing composite oxide can be measured using a laser diffraction particle size distribution measuring device (e.g., MT3000II manufactured by MicrotracBEL Corp.), and using water as a dispersion medium.

The particle size of the primary particles constituting the secondary particles is, for example, 0.05 μm to 1 μm. The particle size of a primary particle is measured as a diameter of a circle circumscribing an image of the particle observed by a scanning electron microscope (SEM).

The ratio of Ca present at the surface of the secondary particles of the lithium-containing composite oxide (hereinafter referred to as the Ca surface abundance ratio) relative to the total amount of Ca present at the surface and in the interior of the secondary particles is preferably 12% to 58%, more preferably 12% to 31%, and even more preferably 12% to 20%. By setting the Ca surface abundance ratio within this range, sufficient charge-discharge cycle characteristic and safety can be simultaneously achieved. It is presumed that Ca present at the surface of the secondary particles inhibits reaction with the electrolyte solution and thereby suppresses an increase in internal resistance of the battery due to repeated charging and discharging, and at the same time, Ca present in the interior of the secondary particles suppresses thennal decomposition of the positive electrode active material.

The Ca surface abundance ratio is measured as follows.

### (1) Measurement of Total Amount of Ca Present at Surface and in Interior of Secondary Particles

Into 0.2 g of a positive electrode active material powder, 10 mL of aqua regia is added dropwise, and subsequently 2.5 mL of hydrofluoric acid is added dropwise. The mixture is heated, and the powder is completely dissolved to produce an aqueous solution. The volume of the aqueous solution is adjusted to 100 mL with ion-exchanged water. A result obtained by measuring the Ca concentration by ICP-AES is used as the total amount of Ca present at the surface and in the interior of the secondary particles.

### (2) Measurement of Amount of Ca Present at Surface of Secondary Particles

4 g of the positive electrode active material powder is stirred in 400 mL of sodium hydroxide solution having a concentration of 0.01 mol/L at 40° C. for 5 minutes, and then the mixture is filtered using a syringe filter having a pore size of 0.45 prn to obtain a filtrate. Into 4 mL of this filtrate, 2.5 mL of aqua regia is added dropwise, and subsequently 0.6 mL of hydrofluoric acid is added dropwise. The mixture is heated, and the powder remaining in the filtrate is completely dissolved to produce an aqueous solution. The volume of the aqueous solution is adjusted to 100 mL with ion-exchanged water. A result obtained by measuring the Ca concentration by ICP-AES is used as the total amount of Ca present at the surface of the secondary particles.

### (3) Calculation of Ca Surface Abundance Ratio

Using the above measurement results, the Ca surface abundance ratio is calculated by the following formula.

Ca surface abundance ratio=(amount of Ca present at the surface of secondary particles)/(total amount of Ca present at the surface and in the interior of secondary particles)

At the surface of the secondary particles and in the interior of the secondary particles, Ca may be present in the form of a Ca compound containing Ca. Examples of the Ca compound include CaO, Ca(OH)₂, CaCO₃, and the like.

Next, an example method of producing the lithium-containing composite oxide will be described.

The method of producing the lithium-containing composite oxide includes: a process of mixing a composite oxide containing at least Ni, Co, and Al, a Li raw material such as LiOH, Li₂O, or Li₂CO₃, and a Ca raw material such as Ca(OH)₂, CaO, or CaCO₃, and firing the mixture to obtain a fired product; a process of washing the fired product with water and dewatering the product to obtain a cake-like composition having a predetermined moisture content; and a process of beat-treating the cake-like composition to obtain the lithium-containing composite oxide.

<Fired Product Synthesizing Process>

First, a composite oxide containing Ni, Co, and Al, a Li raw material such as lithium hydroxide (LiOH) or lithium carbonate, and a Ca raw material such as CaO, Ca(OH)₂, or CaCO₃ are provided. The composite oxide can be obtained, for example, by heat-treating a composite hydroxide such as a nickel-cobalt-aluminum composite hydroxide obtained by coprecipitation. Next, the composite oxide, the Li raw material, and the Ca raw material are mixed, and this mixture is fired and then pulverized to obtain particles of the fired product. As a result of studies by the present inventors, it has been found that the Ca surface abundance ratio can be adjusted by controlling the firing conditions. For example, the Ca surface abundance ratio can be lowered by increasing the firing temperature. It is presumed that an increase in the firing temperature promotes reaction of Ca with Li or the like in the interior of the secondary particles of the lithium-containing composite oxide.

<Cake-Like Composition Producing Process>

Next, the fired product is washed with water and dewatered to obtain a cake-like composition. As the fired product, the particulate material obtained in the above synthesizing process can be used. By washing with water, it is possible to remove unreacted part of the Li raw material added in the fired product synthesizing process, and to also remove impurities other than the Li raw material. When washing with water, for example, 300 g to 5000 g of the fired product can be put into 1 L of water. The washing with water may be repeated a plurality of times. The dewatering after the washing with water can be carried out, for example, by a filter press. By controlling the dewatering conditions, the moisture content of the cake-like composition after washing (hereinafter referred to as the cake moisture content) can be adjusted. As a result of studies by the present inventors, it has been found that by increasing the cake moisture content, the Ca surface abundance ratio of the lithium-containing composite oxide can be increased. By adjusting the cake moisture content within a predetermined range, the Ca surface abundance ratio can be set to 12% to 58%. The cake moisture content can be calculated by drying 10 g of the cake-like composition by leaving it to stand in a vacuum at 120° C. for 2 hours, and dividing the change in mass of the cake-like composition before and after the drying by the mass of the cake-like composition before the drying.

<Lithium-Containing Composite Oxide Synthesizing Step>

The lithium-containing composite oxide can be obtained by heat-treating the above cake-like composition. Although the heat treatment conditions are not particularly limited, for example, the heat treatment temperature can be set to 150° C. to 400° C., and the heat treatment time can be set to 0.5 hours to 15 hours.

[Negative Electrode]

The negative electrode comprises a negative electrode current collector and a negative electrode mixture layer formed on a surface of the negative electrode current collector. The negative electrode mixture layer is preferably formed on both sides of the negative electrode current collector. As the negative electrode current collector, it is possible to use: a foil of a metal, such as copper, that is stable in the potential range of the negative electrode; a film having such a metal disposed on its surface layer; and the like. The negative electrode mixture layer contains a negative electrode active material, and preferably additionally contains a thickener, a binder, and the like. The negative electrode can be produced by, for example, applying onto the negative electrode current collector a negative electrode mixture slurry in which the negative electrode active material, the thickener, and the binder are dispersed in water at a predetermined mass ratio, drying the applied coating, and then rolling the coating to thereby form negative electrode mixture layers on both sides of the negative electrode current collector.

As the negative electrode active material, a carbon material capable of occluding and releasing lithium ions can be used. Apart from graphite, it is possible to use non-graphitizable carbon, graphitizable carbon, fibrous carbon, coke, carbon black, and the like. Furthermore, it is possible to use silicon, tin, and alloys and oxides based thereon, which are non-carbon-based materials.

As the binder, while a fluorocarbon resin or the like can be used as in the case of the positive electrode, it is also possible to use a styrene-butadiene copolymer (SBR), a modified product thereof, or the like. As the thickener, carboxymethyl cellulose (CMC) or the like can be used.

[Separator]

As the separator 13, for example, a porous sheet having ion permeability and insulation property is used. Specific examples of the porous sheet include a microporous film, woven fabric, and non-woven fabric. As the material of the separator, olefin resins such as polyethylene and polypropylene, cellulose, and the like are suitable. The separator 13 may be a laminate having a cellulose fiber layer and a layer of thermoplastic resin fibers made of olefin resin or the like. Further, the separator may be a multilayer separator including a polyethylene layer and a polypropylene layer. It is also possible to use a separator 13 having a surface coated with a material such as aramid resin or ceramic.

[Non-Aqueous Electrolyte]

The non-aqueous electrolyte contains a non-aqueous solvent and an electrolyte salt dissolved in the non-aqueous solvent. The non-aqueous electrolyte is not limited to a liquid electrolyte (electrolyte solution), and may be a solid electrolyte that uses a gel polymer or the like. As the non-aqueous solvent, it is possible to use, for example, esters, ethers, nitriles such as acetonitrile, amides such as dimethylformamide, a mixed solvent containing two or more of the foregoing, and the like. The non-aqueous solvent may contain a halogen-substituted product obtained by substituting at least a part of hydrogens in the above solvents with halogen atoms such as fluorine.

Examples of the above-noted esters include: cyclic carbonate esters such as ethylene carbonate (EC), propylene carbonate (PC), and butylene carbonate; chain carbonate esters such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylate esters such as γ-butyrolactone and γ-valerolactone; and chain carboxylate esters such as methyl acetate, ethyl acetate, propyl acetate, methyl propionate (MP), and ethyl propionate.

Examples of the above-noted ethers include: cyclic ethers such as 1,3-dioxolane, 4-methyl-1,3-dioxolane, tetrahydrofuran, 2-methyltetrahydrofran, propylene oxide, 1,2-butylene oxide, 1,3-dioxane, 1,4-dioxane, 1,3,5-trioxane, furan, 2-methylfuran, 1,8-cineole, and crown ethers: and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the above-noted halogen-substituted product, it is preferable to use fluorinated cyclic carbonate esters such as fluoroethylene carbonate (FEC), fluorinated chain carbonate esters, fluorinated chain carboxylate esters such as methyl fluoropropionate (FMP), and the like.

The electrolyte salt is preferably lithium salt. Examples of lithium salt include LiBF₄, LiCIO₄, LiPF₆, LiAsF₆, LiSbF₆, LiAlCI₄, LiSCN, LiCF₃SO₃, LiCF₃CO₂, Li(P(C₂O₄)F₄). LiPF₆₋ₓ(CₙF₂ₙ₊₁)(where 1<x<6, and n is 1 or 2). LiB₁₀Cl₁₀, LiCl, LiBr, LiL chloroborane lithium, lower aliphatic lithium carboxylate, borates such as Li₂B₄₀₇ and Li(B(C₂O₄)F₂), and imide salts such as LiN(SO₂CF₃)₂ and LiN(C₁F₂ₗ₊₁SO₂)(CₘF₂ₘ₊₁SO₂) (where each of l and m is an integer of 1 or greater). As the lithium salt, a single type among the above may be used alone, or a plurality of types may be mixed and used. Among the foregoing, it is preferable to use LiPF₆ in consideration of ion conductivity, electrochemical stability, and the like. The concentration of the lithium salt is preferably 0.8 to 1.8 mol per 1 liter of the solvent.

### EXAMPLES

While the present disclosure will be further described below using Examples, the present disclosure is not limited to these Examples.

[Preparation of Positive Electrode Active Material]

### Example 1

A composite oxide represented by general formula Ni_{0.91}Co_{0.04}Al_{0.05}O₂, Ca(OH)₂, and LiOH were mixed so that the molar ratio of the total amount of Ni, Co, and Al, Ca, and Li was 1:0.0028:1.02, and the mixture was fired to obtain a fired product. Next, the fired product was washed with water and dewatered by a filter press, and a cake-like composition having a predetermined moisture content was obtained. Further, the cake-like composition was heat-treated under an oxygen stream having an oxygen concentration of 95% (with a flow rate of 5 L/min per 1 kg of the mixture) at a heating rate of 2° C./min from room temperature to 650° C., and subsequently at a heating rate of 1° C./min from 650° C. to 800° C., and a positive electrode active material of Example 1 was thereby obtained. As a result of analyzing the positive electrode active material of Example 1 by ICP-AES, the composition was LiNi_{0.91}Co_{0.04}Al_{0.05}Ca_{0.0028}O₂.

[Production of Positive Electrode]

A positive electrode mixture slurry was prepared by mixing 100 parts by mass of the above positive electrode active material, 1 part by mass of acetylene black (AB) as a conductive agent, and 0.9 parts by mass of polyvinylidene fluoride (PVdF) as a binder, and further adding thereto an appropriate amount of N-methyl-2-pyrrolidone (NMP). Next, the positive electrode mixture slurry was applied to both sides of a positive electrode current collector made of aluminum foil, and the applied coating was dried and then rolled using a roller. The product was cut into a predetermined electrode size, and a positive electrode having positive electrode mixture layers formed on both sides of the positive electrode current collector was thereby obtained. At a part of the positive electrode, there was provided an exposed portion where a surface of the positive electrode current collector was exposed.

[Production of Negative Electrode]

A mixture was formed to include graphite in 94 parts by mass and SiO in 6 parts by mass, and this mixture was used as a negative electrode active material. A negative electrode mixture slurry was prepared by mixing 95 parts by mass of the negative electrode active material, 3 parts by mass of carboxymethyl cellulose (CMC) as a thickener, and 2 parts by mass of styrene-butadiene rubber (SBR) as a binder, and further adding thereto an appropriate amount of water. This negative electrode mixture sluny was applied to both sides of a negative electrode current collector made of copper foil, and the applied coating was dried and then rolled using a roller. The product was cut into a predetermined electrode size, and a negative electrode having negative electrode mixture layers formed on both sides of the negative electrode current collector was thereby obtained. At a part of the negative electrode, there was provided an exposed portion where a surface of the negative electrode current collector was exposed.

[Preparation of Non-Aqueous Electrolyte]

Ethylene carbonate (EC) and ethyl methyl carbonate (EMC) were mixed at a volume ratio of 30:70. Lithium hexafluorophosphate (LiPF₆) was added to this mixed solvent at a concentration of 1 mol/liter, and a non-aqueous electrolyte was thereby prepared.

[Production of Test Cell]

An aluminum lead was attached to the exposed portion of the above positive electrode, and a nickel lead was attached to the exposed portion of the above negative electrode. The positive electrode and the negative electrode were spirally wound with a separator made of polyolefin microporous film disposed between those electrodes, and the product was shaped by being pressed in a radial direction to produce a flat-shaped spiral-type electrode assembly. This electrode assembly was housed in an outer casing, and after injecting the above non-aqueous electrolyte therein, the opening of the outer casing was sealed, and a test cell was thereby obtained.

[ARC Test]

In an environment of 25° C., the above test cell was charged at a constant current of 0.3 It until the battery voltage reached 4.2 V, and was then charged at a constant voltage of 4.2 V until the current value reached 0.05 It, so that a charged state was achieved. After that, the test cell in the above charged state was set in an adiabatic runaway reaction calorimeter (ARC), and by observing the cell temperature with a thermocouple attached to the test cell, the self-heating rate (° C./min) of the test cell under an adiabatic environment was measured. More specifically, the temperature of the test cell was repeatedly measured while increasing the temperature at 5° C./min, and at the point when the self-heating rate reached 1° C./min according to the Arrhenius plot, control was switched to adiabatic control, and this control was continued until heat generation occurred. The battery temperature (° C.) at the time when the self-heating rate of the test cell reached 2° C./min was defined as the thermal runaway temperature.

[Evaluation of Capacity Retention Rate]

In an environment of 25° C., the above test cell was charged at a constant current of 0.5 It until the battery voltage reached 4.2 V, and was then charged at a constant voltage of 4.2 V until the current value reached 1/50 It. After that, discharging was performed at a constant current of 0.5 It until the battery voltage reached 2.5 V. This charging and discharging process was used as one cycle, and 400 cycles were carried out. The capacity retention rate of the test cell over the charging and discharging cycles was determined by the following formula.

capacity retention rate=(discharge capacity in the 400th cycle/discharge capacity in the 1st cycle)×100

### Example 2

A test cell was produced and evaluation was performed in the same manner as in Example 1 except that, in the preparation of the positive electrode active material, the cake moisture content was increased.

### Example 3

A test cell was produced and evaluation was performed in the same manner as in Example 1 except that, in the preparation of the positive electrode active material, the amount of Ca(OH)₂ added was changed so that the molar ratio of the total amount of Ni, Co, and Al to Ca was 1:0.0017.

### Example 4

A test cell was produced and evaluation was performed in the same manner as in Example 1 except that, in the preparation of the positive electrode active material, the amount of Ca(OH)₂ added was changed so that the molar ratio of the total amount of Ni, Co, and Al to Ca was 1:0.0041.

### Comparative Example 1

A test cell was produced and evaluation was performed in the same manner as in Example 1 except that, in the preparation of the positive electrode active material, the amount of Ca(OH)₂ added was changed so that the molar ratio of the total amount of Ni, Co, and Al to Ca was 1:0.0025, and the cake moisture content was made higher than in Example 2.

### Comparative Example 2

A test cell was produced and evaluation was performed in the same manner as in Example 1 except that, in the preparation of the positive electrode active material, the amount of Ca(OH)₂ added was changed so that the molar ratio of the total amount of Ni, Co, and Al to Ca was 1:0.0024, and the firing temperature was increased.

Table 1 shows the evaluation results of each of the test cells of the Examples and Comparative Examples. In Table 1, the results of the Examples and Comparative Examples are indicated as values relative to the capacity retention rate (%) and thermal runaway temperature (° C.) of the test cell of Comparative Example 1, which are assumed to be 100. Table 1 also shows the Ca element content (mol %) relative to the total number of moles of metal elements excluding Li in the cake-like composition, the cake moisture content, the firing temperature, and the Ca surface abundance ratio. The cake moisture content is expressed by relative evaluation values of “+2”, “+1”, and “0 (reference)” in descending order of moisture content, with the cake moisture content of Example 1 being denoted as “0 (reference)”. Further, as to the firing temperature, the condition of Example 1 is denoted as “0 (reference)”, and a higher temperature is expressed by a relative evaluation value of “+1”.

TABLE 1

| | Ca | Cake | | Ca Surface | Thermal | Capacity |
|---|---|---|---|---|---|---|
| | Content | Moisture | Firing | Abundance | Runaway | Retention |
| | [mol %] | Content | Temperature | Ratio [%] | Temperature | Rate |
| Example 1 | 0.28 | 0 | 0 | 14.8 | 102.7 | 101.0 |
| Example 2 | 0.28 | +1 | 0 | 30.7 | 100.8 | 100.8 |
| Example 3 | 0.17 | 0 | 0 | 15.7 | 102.1 | 99.8 |
| Example 4 | 0.41 | 0 | 0 | 14.1 | 102.0 | 100.7 |
| Comparative | 0.25 | +2 | 0 | 59.8 | 100 | 100 |
| Example 1 | | | | | | |
| Comparative | 0.24 | 0 | +1 | 10.3 | 99.8 | 99.8 |
| Example 2 | | | | | | |

In Examples 1 to 4 in which Ca was included at a predetermined ratio and the Ca surface abundance ratio was within a predetermined range, a capacity retention rate equivalent to that of Comparative Example 1 was maintained, and at the same time, the thermal runaway temperature was higher than in Comparative Example 1, so that sufficient charge-discharge cycle characteristic and safety were simultaneously achieved. On the other hand, in Comparative Example 2 in which the Ca surface abundance ratio was less than 12%, the thermal runaway temperature was lower than in Comparative Example 1.

### REFERENCE SIGNS LIST

10 secondary battery; 11 positive electrode; 12 negative electrode; 13 separator; 14 electrode assembly; 15 outer casing; 16 sealing assembly; 17, 18 insulation plate; 19 positive electrode lead; 20 negative electrode lead; 21 grooved portion; 22 filter; 23 lower valve member; 24 insulation member; 25 upper valve member; 26 cap; 26a opening; 27 gasket.

1. A non-aqueous electrolyte secondary battery comprising a positive electrode, a negative electrode, and a non-aqueous electrolyte, wherein
the positive electrode comprises a positive electrode current collector, and a positive electrode mixture layer formed on a surface of the positive electrode current collector and containing a positive electrode active material,
the positive electrode active material contains a lithium-containing composite oxide represented by general formula LiₐNi_{b}Co_{c}Al_{d}MₑCa_{f}O_{g} (where 0.9≤a≤1.2, 0.8≤b≤0.95, 0<c≤0.1, 0<d≤0.1, 0≤e≤0.1, b+c+d+e=1, 0.0005≤f/(b+c+d+e+f)≤0.01, 1.9≤g≤2.1, and M is at least one element selected from Mn, Fe, Ti, Si, Nb, Zr, Mo, and Zn),
the lithium-containing composite oxide includes secondary particles formed by agglomeration of primary particles, Ca is present at surface and in interior of the secondary particles, and a ratio of Ca present at the surface of the secondary particles relative to a total amount of Ca present at the surface and in the interior of the secondary particles is 12% to 58%.

2. The non-aqueous electrolyte secondary battery according to claim 1, wherein the ratio of Ca present at the surface of the secondary particles relative to the total amount of Ca present at the surface and in the interior of the secondary particles is 12% to 31%.

3. The non-aqueous electrolyte secondary battery according to claim 1, wherein the ratio of Ca present at the surface of the secondary particles relative to the total amount of Ca present at the surface and in the interior of the secondary particles is 12% to 20%.
